(19) United States
(12) Patent Application Publication
(10) Pub. No.: US 2026/0017490 A1
(43) Pub. Date: Jan. 15, 2026

(54) QUESTION ANSWERING CONTEXT USING MACHINE LEARNING

(71) Applicant: Adobe Inc., San Jose, CA (US)

(72) Inventors: Koustava Goswami, Bengaluru (IN); Natwar Modani, Bangalore (IN); Inderjeet Jayakumar Nair, Indore (IN); Barah Fazili, Srinagar (IN); Balaji Vasan Srinivasan, Bangalore (IN)

(73) Assignee: Adobe Inc., San Jose, CA (US)

(21) Appl. No.: 18/767,913

(22) Filed: Jul. 9, 2024

(51) Int. Cl. G06N 3/0455

(52) U.S. Cl. CPC G06N 3/0455

(57) ABSTRACT

Question answering context techniques using machine learning are described. In one or more examples, a question to be answered is received and a prompt is formed to cause a generator machine-learning model to generate a sub-question based on the question using generative artificial intelligence (AI). Generation of a plurality of passage scores by a scoring machine-learning model is prompted for a plurality of passages of digital content based on the sub-question. A passage is selected from the plurality of passages based on the passage scores. An additional prompt is formed to cause a generator machine-learning model to generate an answer to the question based on the question. The additional prompt includes the question, the sub-question, and the selected passage as context to the question.

### BACKGROUND

Search forms a basis for a wide range of functionalities implemented by computing devices. An example of which is referred to as “question answering” in which the computing devices as part of a question answering system are tasked with generating a search result as an answer to a question posed by a query. Machine-learning models were then developed to expand the richness and accuracy of search results generated by the question answering system. However, conventional techniques utilized to implement machine-learning models as part of question answering are often confronted with a variety of technical challenges that hinder search accuracy.

### SUMMARY

Question answering context techniques are described. In one or more examples, these techniques employ machine learning and question decomposition-based passage alignment to improve accuracy and reduce computational consumption of computing devices that implement question answering. A context manager system, for instance, is employed to select passages from one or more items of digital content based on a predicted decomposition of a question. The passages are used along with sub-questions used to select the passages to support a context for a question for processing by a machine-learning model.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures are indicative of one or more entities and thus reference is made interchangeably to single or plural forms of the entities in the discussion.

FIG. 1 is an illustration of a digital medium environment in an example implementation that is operable to employ question answering context techniques using machine learning as described herein.

FIG. 2 depicts a system in an example implementation showing operation of a context manager system and machine-learning system of FIG. 1 in greater detail as generating an answer to a question by leveraging a passage selection from digital content.

FIG. 3 depicts an example of a question and context usable to generate an answer from the generator machine-learning model of FIG. 2.

FIG. 4 depicts an example of a question and context and corresponding sub-questions usable to generate an answer from a generator machine-learning model of FIG. 2.

FIG. 5 depicts an example of a prompt for computing a value of an introduced stopping criterion using a scoring machine-learning model of FIG. 2.

FIG. 6 depicts an example of a prompt form computing passage scores as relevance scores using the scoring machine-learning model of FIG. 2.

FIG. 7 depicts a first stage of an example of question and sub-question generation with passage scoring and selection.

FIG. 8 depicts a second stage of an example of question and sub-question generation with passage scoring and selection.

FIG. 9 depicts a third stage of an example of question and sub-question generation with passage scoring and selection.

FIG. 10 is a flow diagram depicting an algorithm as a step-by-step procedure in an example implementation of operations performable for accomplishing a result of question answering context generation using machine learning to implement search.

FIG. 11 depicts an algorithm in an example implementation as a step-by-step procedure in an example implementation of operations performable using two machine-learning models to implement a generator machine-learning model and a scoring machine-learning model to generate an answer to a question.

FIG. 12 illustrates an example system including various components of an example device that can be implemented as any type of computing device as described and/or utilize with reference to the previous figures to implement embodiments of the techniques described herein.

### DETAILED DESCRIPTION

### Overview

Question answering is a form of search implemented by computing devices in which a search result contains an answer to a question posed by a query. Machine-learning models, and particularly large language models, have expanded a richness and functionality that is available as part of question answering through an ability to “reason through” a question to derive an answer. To do so, the large language model is trained using training data to identify patterns in support of how to reason from a question posed by the query to the answer included in the search result.

Conventional search techniques have been developed to expand accuracy in generating the search result by furnishing relevant context within a prompt to aid in answer generation. However, in real world scenarios inaccuracies may occur due to a variety of factors, examples of which include inadequate or distracting context which causes an inability of the machine-learning model to effectively “reason through the facts.”

To address these and other technical challenges, question answering context techniques are described. These techniques employ machine learning and question decomposition based passage alignment to improve accuracy and reduce computational consumption of computing device that implement question answering. A context manager system, for instance, is incorporated as part of a search system (e.g., locally and/or implemented remotely as a digital service) to select passages from one or more items of digital content based on a predicted decomposition of a question involving “multiple hops.”

A multi-hop question, for instance, involves a question that is not directly answerable by an item of digital content but rather involves intervening reasoning to do so, i.e., the “hops” in the reasoning. A question of “what other songs are written by the author of ‘Alexander's Ragtime Band,’” for instance, may involve first determining an author of “Alexander's Ragtime Band” as “Irving Berlin” and then determining other songs written by “Irving Berlin” to arrive at an answer, e.g., “Always” and “All Alone.” Accordingly, in the techniques described herein the context manager module is configured to provide the context to the machine-learning model in order to generate an accurate answer.

To do so in one or more examples, the context manager system is configured to locate passages that support the context. In these examples, the context manager system operates different from conventional techniques that generate a series of answers sequentially as a “chain-of-reasoning” in an attempt to answer the question. In practice, these conventional techniques have exhibited an increased likelihood of encountering “hallucination” in the answer that is incorrect and nonsensical due to errors in a pattern used to “reason through” the questions to the answer, i.e., inaccuracies in the chain of reasoning. However, use of passages to arrive at the answer as performed in the techniques described herein protect against this technical challenge and reduce a likelihood of hallucination in generating the answer by providing the context as a whole which is then usable to support reasoning in answer generation.

For example, the context, as passages from digital content, are identified sequentially through successive prompts to generate sub-questions and identify corresponding passages until a stopping criterion is met. The stopping criterion, for instance, may be based on a detected likelihood of redundancy of a respective sub-question in generating the answer. Once met, a prompt including the question, sub-questions, and corresponding passages is then used as to cause a machine-learning model (e.g., LLM) to generate an answer to the question.

The prompt, sub-questions, and corresponding passages, for instance, are ordered sequentially in the prompt as corresponding to an order, in which, the sub-questions and passages are generated. This ordering has exhibited improved accuracy and reduced computational consumption when processed by a computing device. Additionally, through inclusion of the sub-questions and passages the machine-learning model is provided with additional context that is not possible in conventional techniques. Further discussion of these and other examples is included in the following sections and shown in corresponding figures.

### Term Examples

A “machine-learning model” refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

A “large language model” (LLM) is a type of machine-learning model that is designed to understand, generate, and interact with human language inputs at a large scale. These machine-learning models are trained on vast amounts of text data using deep learning techniques (e.g., neural networks) to learn patterns, nuances, and the structure of language. The use of the term “large” refers to both the size of the training data and also to the complexity and scale of the neural networks, which may include billions or even trillions of parameters.

Large language models (LLMs) are configurable to perform a wide range of language-related tasks without being explicitly programmed for each one.

Examples of these tasks include text generation, translation, summarization, question answering, sentiment analysis, and natural language processing. To train a large language model, the underlying machine-learning model is provided with training data that includes examples of text to train and retrain the model to predict a next word in a sequence. Over time, the model, once trained, is configured to generate text that is coherent and contextually relevant, is configurable to mimic a style and content of the training data, and so forth. In this way, large language models provide a foundational tool in artificial intelligence for understanding and generating human language, powering a wide range of applications from conversational agents to content creation tools.

In the following discussion, an example environment is described that employs the techniques described herein. Example procedures are also described that are performable in the example environment as well as other environments. Consequently, performance of the example procedures is not limited to the example environment and the example environment is not limited to performance of the example procedures.

### Example Question Answering Context Environment

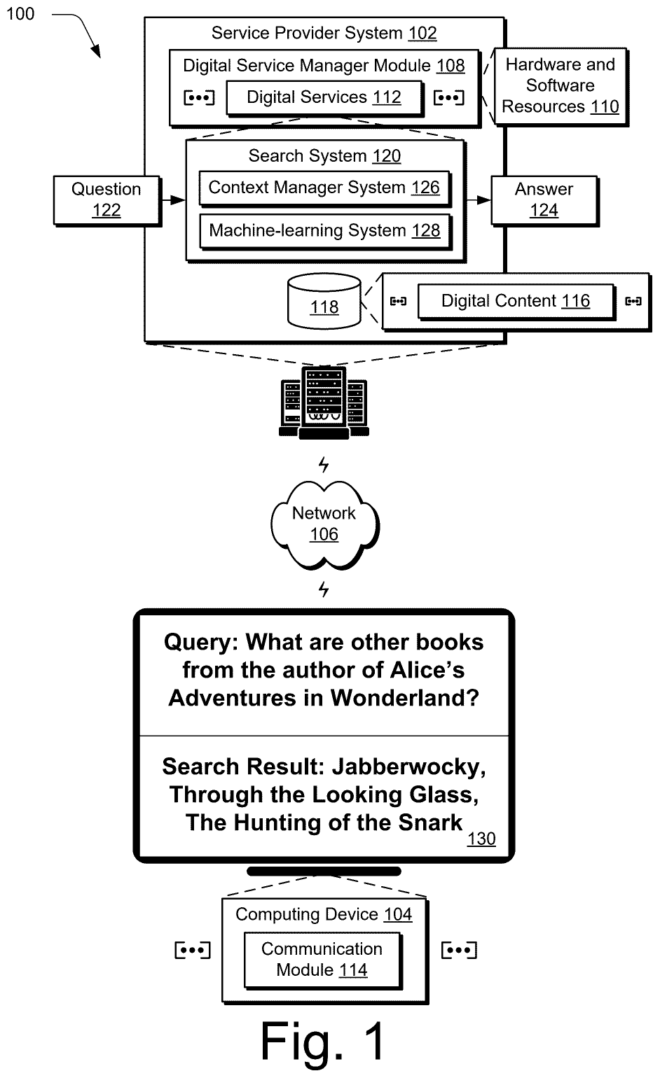

FIG. 1 is an illustration of a digital medium environment 100 in an example implementation that is operable to employ question answering context techniques using machine learning as described herein. The illustrated environment 100 includes a service provider system 102 and a computing device 104 that are communicatively coupled, one to another, via a network 106. Computing devices are configurable in a variety of ways.

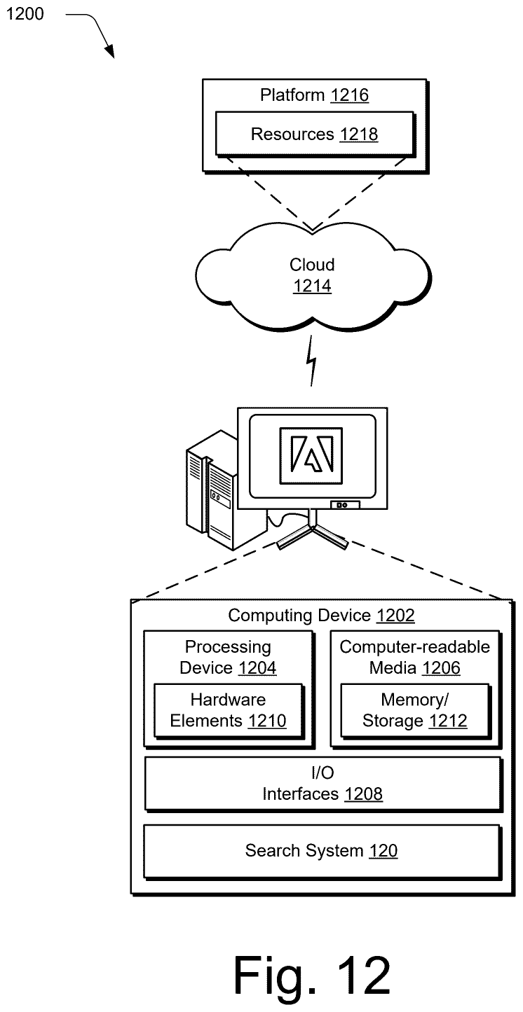

A computing device, for instance, is configurable as a desktop computer, a laptop computer, a mobile device (e.g., assuming a handheld configuration such as a tablet or mobile phone), and so forth. Thus, a computing device ranges from full resource devices with substantial memory and processor resources (e.g., personal computers, game consoles) to a low-resource device with limited memory and/or processing resources, e.g., mobile devices. Additionally, although a single computing device is shown and described in instances in the following discussion, a computing device is also representative of a plurality of different devices, such as multiple servers utilized by a business to perform operations “over the cloud” for the service provider system 102 and as further described in relation to FIG. 12.

The service provider system 102 includes a digital service manager module 108 that is implemented using hardware and software resources 110 (e.g., a processing device and computer-readable storage medium) in support one or more digital services 112. Digital services 112 are made available, remotely, via the network 106 to computing devices, e.g., computing device 104.

Digital services 112 are scalable through implementation by the hardware and software resources 110 and support a variety of functionalities, including accessibility, verification, real-time processing, analytics, load balancing, and so forth. Examples of digital services include a social media service, streaming service, digital content repository service, content collaboration service, and so on. Accordingly, in the illustrated example, a communication module 114 (e.g., browser, network-enabled application, and so on) is utilized by the computing device 104 to access the one or more digital services 112 via the network 106. A result of processing using the digital services 112 is then returned to the computing device 104 via the network 106.

The service provider system 102 also includes one or more items of digital content 116 which are illustrated as maintained locally in a storage device 118 but are also accessible remotely via the network 106. The digital content 116 is configurable in a variety of ways, examples of which include digital documents, digital media, digital images, digital audio, webpages, in compliance with a portable document format (PDF), and so forth.

In the illustrated example, the digital services 112 are utilized to implement a search system 120 that is configured to receive a question 122 (e.g., as posed by a query) and process the question 122 to arrive at an answer 124, e.g., as a search result. To do so, the search system 120 employs a context manager system 126 that is configured to provide a context to the question 122 by leveraging passages from the digital content 116. The context provided from the digital content 116 supports an ability of a machine-learning system 128 to “reason through” the question 122 in order to generate the answer 124 with improved accuracy while addressing technical challenges of “hallucination” as are encountered by conventional techniques.

Retrieval augmented generation (RAG) as part of question answering, for instance, involves presenting a machine-learning model with a context in support a ground truth answer alongside a posed question. This technique is usable to assess language comprehension and reasoning capabilities of a natural language processing system.

Initially, conventional approaches concentrated on conducting this reasoning within a singular context and then expanded to address multi-hop question answering (MHQA). Multi-hop question answering involves asking a one or more preliminary questions before arriving to a final answer, with each preliminary iteration (e.g., step) feeding into a subsequent iteration to form a reasoning chain. These techniques are usable in support of a variety of functionalities, such as sentence fusion, abstractive summarization, event occurrence time prediction, multi-document summarization, and timeline summarization.

However, technical challenges occur in scenarios in which factual inaccuracy is caused by a lack of supporting data to generate an accurate response, typically due to unfamiliarity with specific entities, attributes, events, and so forth. These inaccuracies cause a bulk of errors in real-world scenarios. Conventional techniques address these technical challenges through use of simplified queries as part of question decomposition, which may include human interaction. Generating answers at each iteration, however, for each of the decomposed questions is resource intensive and tedious with an increased risk of hallucination at each iteration.

Accordingly, the context manager system 126 is configurable to employ question decomposition for passage retrieval. Passage retrieval from digital content 116 is performed in these examples instead of invoking a machine-learning model for answer generation at each step, thereby resulting in lowered latency, higher computational efficiency, and increased accuracy.

The context manager system 126, for instance, invokes the machine-learning system 128 to generate a sub-question based on the question 122 and a context, which is initially empty, as well as sub-questions generated previously for that question 122. Given the generated sub-question, the context manager system 126 ranks passages from the digital content 116, e.g., based on scores computed as a negative log-likelihood using the machine-learning system 128.

A passage is selected based on the ranking (e.g., having a “best” score) and added as context along with the generated sub-question. The context manager system 126 then again generates a subsequent sub-question based on the question 122 and the context. The context manager system 126 sequences through a number of iterations until a stopping criterion is met, upon which the context manager system 126 generate a prompt for generation of a “final” answer 124 to the question 122, e.g., which is then presented for display in a user interface 130.

The question 122, for instance, is expressed as part of a query “What are other books from the author of Alice's Adventures in Wonderland?” Instead of generating answers from the digital content 116 sequentially, the context manager system 126 is configurable to obtain passages over a number of iterations sequentially from the digital content 116. The passages support a line of reasoning that is then usable when included in a prompt together to the machine-learning system 128 to arrive at a final answer 124, e.g., “Jabberwocky,” “Through the Looking Glass,” and “The Hunting of the Snark.” Inclusion of the context together results in increased accuracy over conventional techniques. As a result, these passages protect against potential hallucinations as may occur in conventional techniques, e.g., when an answer in a line of questions is inaccurate thereby causing a nonsensical response.

In this way, the context manager system 126 is configurable to implement a variety of functionality that differs from a simple reranking as part of passage selection. The context manager system 126, for instance, is configurable to identify relevant passages from the digital content 116. The context manager system 126 also arranges the passages in order in the prompt provided to the machine-learning system 128 that is consistent with reasoning steps implemented by the multi-hop question to increase accuracy. Further discussion of these and other examples are included in the following section.

In general, functionality, features, and concepts described in relation to the examples above and below are employed in the context of the example procedures described in this section. Further, functionality, features, and concepts described in relation to different figures and examples in this document are interchangeable among one another and are not limited to implementation in the context of a particular figure or procedure. Moreover, blocks associated with different representative procedures and corresponding figures herein are applicable together and/or combinable in different ways. Thus, individual functionality, features, and concepts described in relation to different example environments, devices, components, figures, and procedures herein are usable in any suitable combinations and are not limited to the particular combinations represented by the enumerated examples in this description.

### Example Question Answering Context Generation

The following discussion describes question answering context techniques that employ machine learning and are implementable utilizing the described systems and devices. Aspects of each of the procedures are implemented in hardware, firmware, software, or a combination thereof. The procedures are shown as a set of blocks that specify operations performable by hardware and are not necessarily limited to the orders shown for performing the operations by the respective blocks. Blocks of the procedures, for instance, specify operations programmable by hardware (e.g., processor, microprocessor, controller, firmware) as instructions thereby creating a special purpose machine for carrying out an algorithm as illustrated by the flow diagram. As a result, the instructions are storable on a computer-readable storage medium that causes the hardware to perform the algorithm.

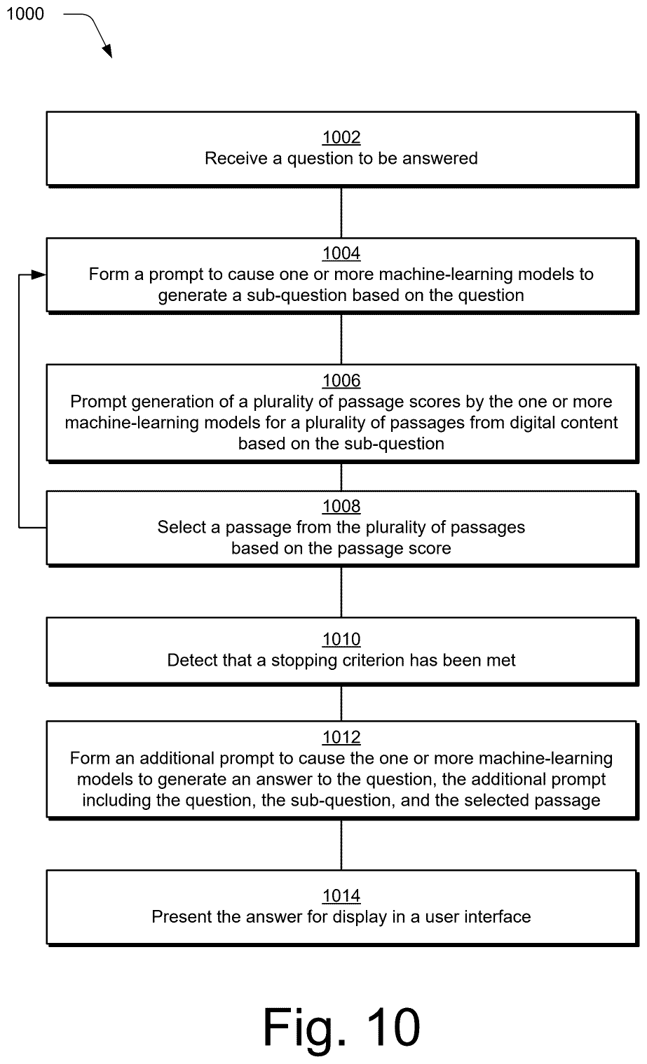

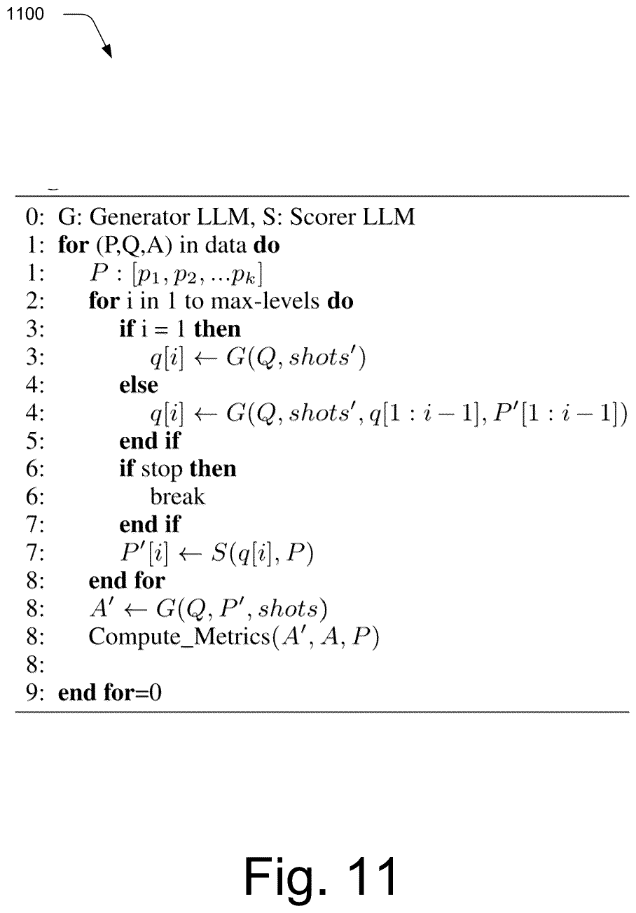

FIG. 10 is a flow diagram depicting an algorithm 1000 as a step-by-step procedure in an example implementation of operations performable for accomplishing a result of question answering context generation using machine learning to implement search. FIG. 11 depicts an algorithm 1100 in an example implementation as a step-by-step procedure in an example implementation of operations performable using two machine-learning models to implement a generator machine-learning model and a scoring machine-learning model to generate an answer to a question. In portions of the following discussion, reference will be made in parallel with FIGS. 10 and 11.

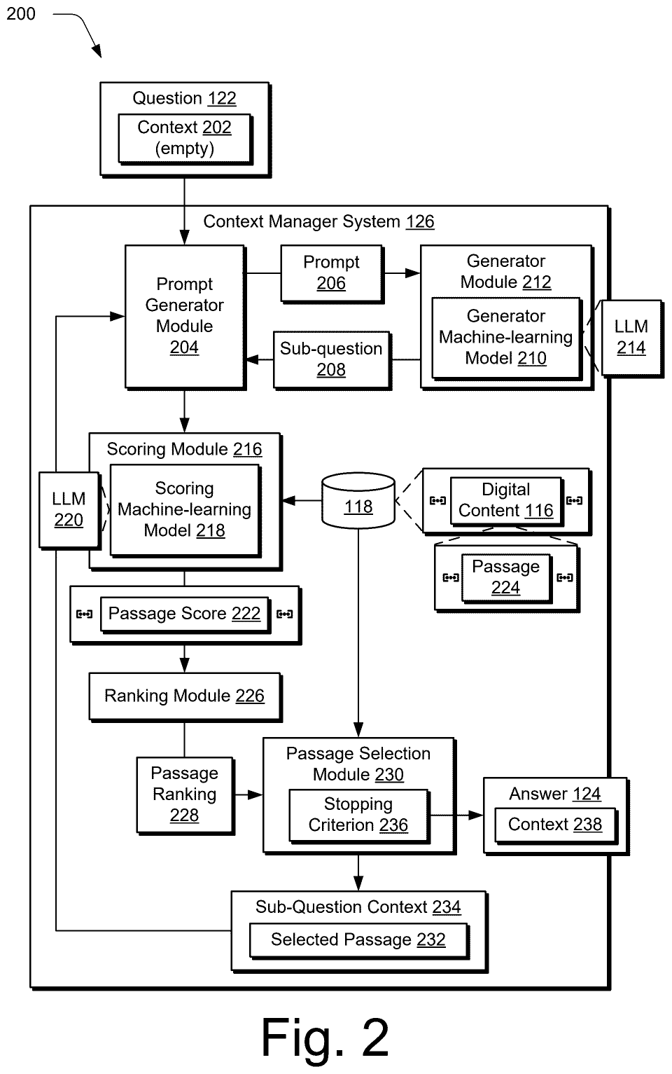

FIG. 2 depicts a system 200 in an example implementation showing operation of the context manager system 126 and machine-learning system 128 of FIG. 1 in greater detail as generating an answer 124 to a question 122 by leveraging a passage selection from digital content 116. To begin, a question 122 to be answered is received (block 1002) by a context manager system 126, e.g., as an input that is typed, uploaded, and so forth. The question 122, for instance is entered via an input received via the user interface 130 of FIG. 1. As such, a context 202 of the question 122 is empty at this point.

A prompt generator module 204 is then employed to form a prompt 206 to cause one or more machine-learning models to generate a sub-question 208 based on the question 122 (block 1004). The one or more machine-learning models, for instance, include a generator machine-learning model 210 as implemented by a generator module 212. The generator machine-learning model 210 is configurable in a variety of ways, an illustrated example of which includes an LLM 214.

The sub-question 208 in this example is then passed as an input to a scoring module 216. The scoring module 216 is configured to prompt a scoring machine-learning model 218 (e.g., an LLM 220) to generate a plurality of passage scores 222 for a plurality of passages 224 from digital content 116 based on the sub-question 208 (block 1006). The plurality of passage scores 222 specify, respectively, “how well” the passages 224 fit the sub-question 208 as further described below.

The passage scores 222 are then passed as an input to a ranking module 226. The ranking module is configured to form a passage ranking 228, e.g., by arranging the passage scores 222 and corresponding passages 224 based on the “fit” to the passage 224 as described above. A passage is then selected by a passage selection module 230 from the plurality of passages 224 (e.g., illustrated as selected passage 232) based on the passage scores 222 (block 1008), e.g., based on the passage ranking 228. The selected passage 232 provides a sub-question context 234 to the sub-question 208, which is used as a basis to form a subsequent prompt 206 by the prompt generator module 204 that is provided as an input to the generator module 212.

This process is configurable to continue over a plurality of iterations until a determination is then made (e.g., by the passage selection module 230 and/or the scoring module 216) that a stopping criterion 236 has been met (block 1010). Once met, the prompt generator module 204 is called to cause formation of an additional prompt to cause the one or more machine-learning models (e.g., the generator machine-learning model 210) to generate an answer 124 to the question. The additional prompt includes the question 122, the sub-question, 208 and the selected passage 232 (block 1012). The answer 124 is then presented for display in a user interface 130 (block 1014), which may include a context 238 to indicate “how” the answer 124 is generated.

For a given question “Q” and a set of passages “P=[p1, p2, . . . , pk],” for instance, a tree of passages is constructed where each node along a greedy path is expanded. Each node for instance, is expanded to “k” child nodes “n_{i,1}, . . . , n_{i,k}” in which a first element in the subscript indicates a level of the node in the tree (e.g., 0-indexed, starting from the root node) and the next element represents the index of the passage included at this node, each corresponding to one of the “k” passages in “P.” Node “n_{i,j}” represents a history of passages included on a greedy path from the root to a respective parent node concatenated with a passage “pⱼ” at the “i^{th}” level.

The sub-question “qi” at each level “i” in the tree is drawn out of the generator machine-learning model 210 “G” using few-shot prompting in this example. The nodes at level “i” are evaluated for relevance to a sub-question “qᵢ” which captures the “i^{th}” reasoning step for a multi-hop question “Q.” The node with a “best” score is chosen by the passage selection module 230 from among the “k” candidates at each level, which is then used to create a next batch of candidates by the prompt generator module 204 up to the final sub-question that is used to form the answer 124. The stopping criterion 236, for instance, is specified as an upper limit based on a number of levels that are explored by leveraging the scoring module 216 in addition to setting an upper bound as further described in relation to FIG. 11 and the below discussion.

For decomposition, a multi-hop question 122 “Q” is provided to the generator machine-learning model 210 “G” along with previously generated sub-questions and corresponding selected passage 232 for each sub-question 208. The prompt 206 is also configurable to include an instruction to flag an end of decomposition, e.g., when additional sub-questions are no longer creatable for “Q” by generating a specified keyword. Apart from relying on the generator machine-learning model 210 “G” for flagging the end of decomposition and a repeated sub question being generated, the stopping criterion 236 may also be based on the log-likelihood scores of the scoring machine-learning model 218 “S.” The scoring machine-learning model 218 “S,” for instance, may be instructed to generate a multi-hop question given a decomposition and the following expression is evaluated where “nll” refers to a negative log-likelihood:

$${nll}_{S} ( p ( Q / C , {q}_{1} , {q}_{2} , … {q}_{i} ) ) > {nll}_{S} ( p ( Q / C , {q}_{1} , {q}_{2} , … {q}_{i - 1} ) )$$

$$C = {p}_{j}^{′} , j ϵ [ 1 , i - 1 ]$$

When the likelihood given the decomposition including the generated sub-question “qᵢ” falls below a likelihood of excluding “qᵢ” from the prompt, the context manager system 126 is stopped from exploring additional passages 224 from the digital content 116 in this example. Note that the prompt to “S” also includes “C” which represents a concatenation of passages selected for “q₁, . . . , qᵢ₋₁” represented as “p_{1′}, . . . , pᵢ₋₁.” The concatenated passages are included to provide context to synthesize (i.e., indirectly score) the composite question. The prompt is designed to extract the passage scores 222 as likelihood scores from the output distribution of “S” for the original question 122 “Q” for the two decompositions.

Once the sub-question “qₘ” has been formulated for level “m,” the context manager system 126 expands a most favorable node from the previous level “(m−1)” into “k” child nodes. Each of these child nodes, denoted as “n_{m,i},” represents a concatenated sequence of passages chosen along the greedy path from a root node to the parent of “n_{m,i},” followed by the passage “pᵢ.” For each child node at level “m,” a score is computed relative to the sub-question “qₘ” using the scoring machine-learning model 218 “S.” The scoring machine-learning model 218 “S” is instructed to produce a question based on the passage sequence represented by each node at level “m,” yielding “m” distinct scores for sub-question “qₘ” as the output text sequence.

The score for node “n_{m,i}” is computed by the scoring machine-learning model 218 by taking a log likelihood of the token sequence “qₘ” in the output distribution of “S” given “pᵢ” to the scoring machine-learning model 218 “S” as follows:

$$score ( {n}_{m , i} ) = {nll}_{S} ( p ( {q}_{m} / {p}_{i} ) ) , i ϵ [ 1 , k ]$$

After passage selection by the passage selection module 230, the generator machine-learning model 210 is called for providing the multi-hop question and selected passage sequence in a few-shot setting to generate the answer 124 as follows:

$$\tilde{A} = G ( Q , {p}_{1}^{′} , … {p}_{m}^{′} )$$

Note that in the log-likelihood expressions, the probability of question is computed conditioned on the passages.

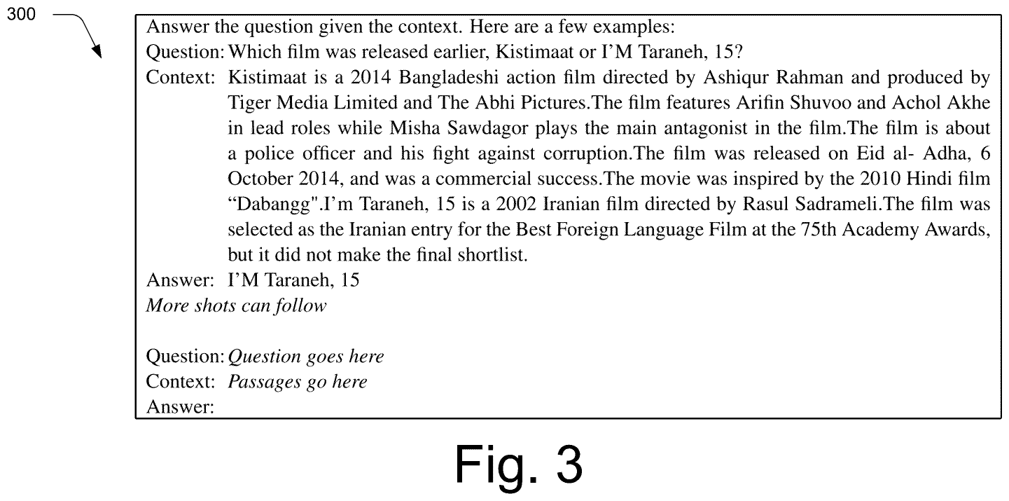

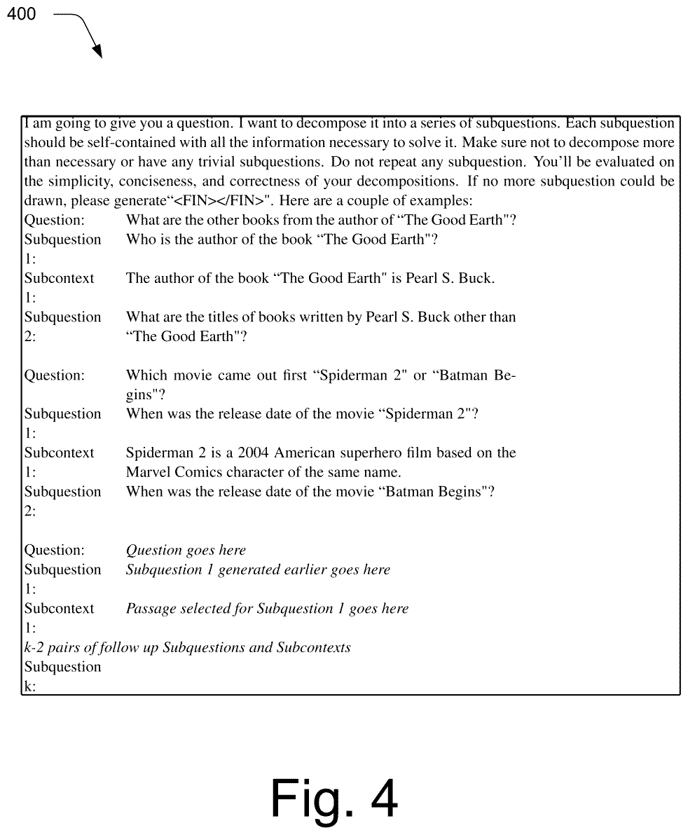

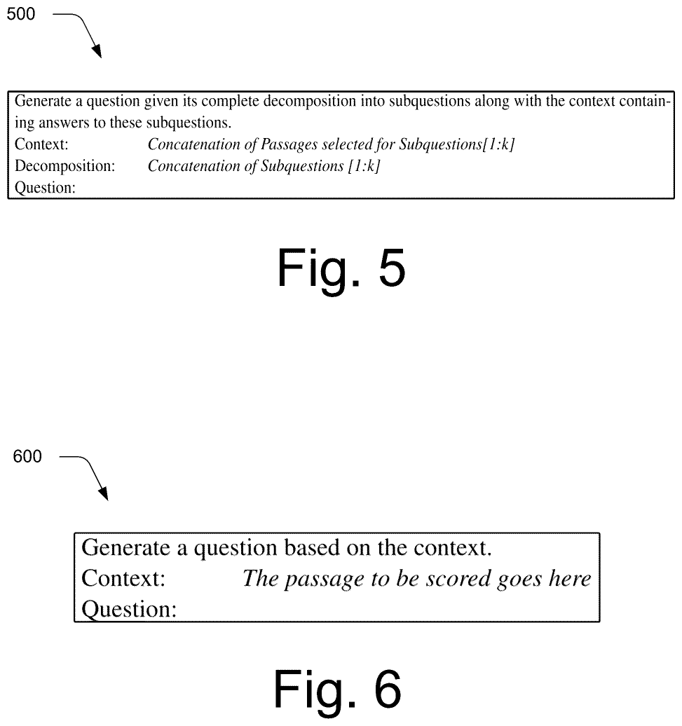

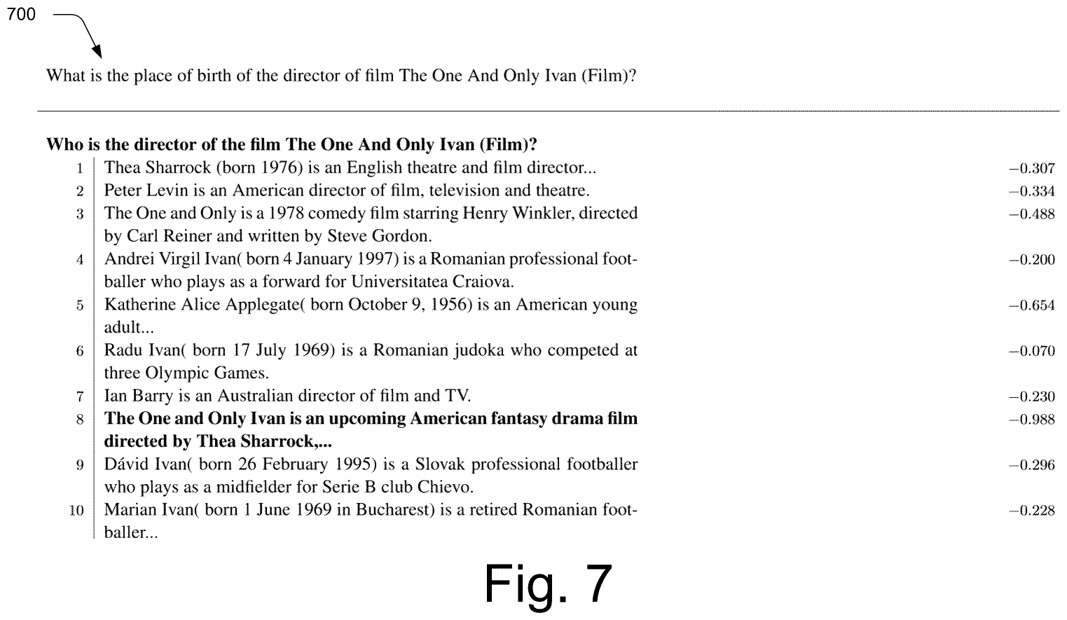

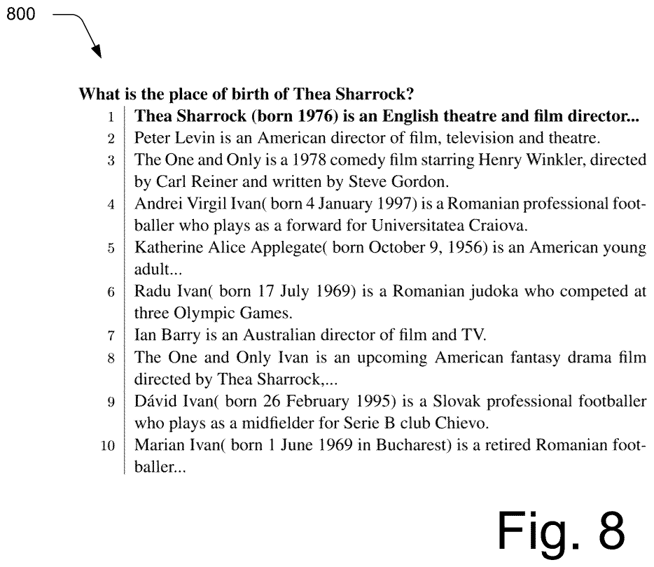

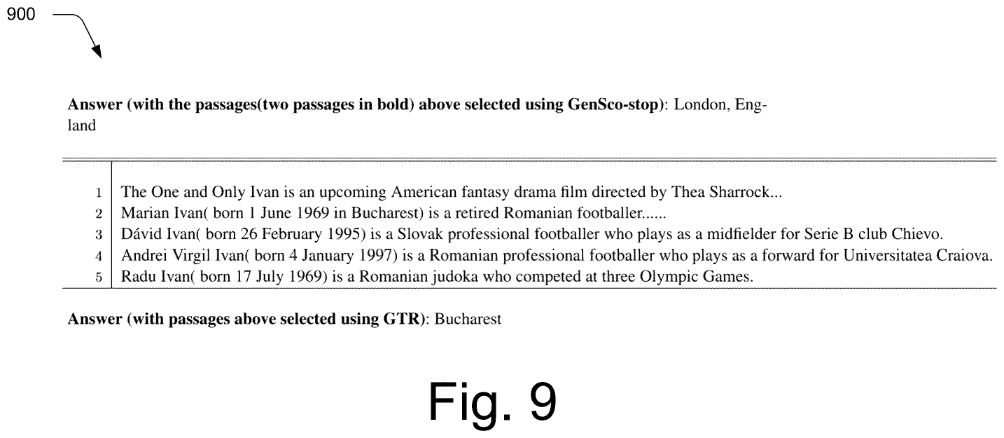

FIG. 3 depicts an example 300 of a question and context usable to generate an answer from the generator machine-learning model 210 of FIG. 2. FIG. 4 depicts an example 400 of a question and context and corresponding sub-questions usable to generate an answer from the generator machine-learning model 210 of FIG. 2. FIG. 5 depicts an example 500 of a prompt for computing a value of an introduced stopping criterion 236 using the scoring machine-learning model 218 of FIG. 2. FIG. 6 depicts an example 600 of a prompt form computing the passage scores 222 as relevance scores using the scoring machine-learning model 218 of FIG. 2. FIG. 7 depicts a first stage 700 of an example of question and sub-question generation with passage scoring and selection. FIG. 8 depicts a second stage of an example 800 of question and sub-question generation with passage scoring and selection. FIG. 9 depicts a third stage of an example 900 of question and sub-question generation with passage scoring and selection.

### Example System and Device

FIG. 12 illustrates an example system generally at 1200 that includes an example computing device 1202 that is representative of one or more computing systems and/or devices that implement the various techniques described herein. This is illustrated through inclusion of the document revision system 120. The computing device 1202 is configurable, for example, as a server of a service provider, a device associated with a client (e.g., a client device), an on-chip system, and/or any other suitable computing device or computing system.

The example computing device 1202 as illustrated includes a processing device 1204, one or more computer-readable media 1206, and one or more I/O interface 1208 that are communicatively coupled, one to another. Although not shown, the computing device 1202 further includes a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing device 1204 is representative of functionality to perform one or more operations using hardware. Accordingly, the processing device 1204 is illustrated as including hardware element 1210 that is configurable as processors, functional blocks, and so forth. This includes implementation in hardware as an application specific integrated circuit or other logic device formed using one or more semiconductors. The hardware elements 1210 are not limited by the materials from which they are formed or the processing mechanisms employed therein. For example, processors are configurable as semiconductor(s) and/or transistors (e.g., electronic integrated circuits (ICs)). In such a context, processor-executable instructions are electronically-executable instructions.

The computer-readable storage media 1206 is illustrated as including memory/storage 1212 that stores instructions that are executable to cause the processing device 1204 to perform operations. The computer-readable storage medium is configured for storing instructions that, responsive to execution by the processing device, causes the processing device to perform operations. The memory/storage 1212 represents memory/storage capacity associated with one or more computer-readable media. The memory/storage 1212 includes volatile media (such as random access memory (RAM)) and/or nonvolatile media (such as read only memory (ROM), Flash memory, optical disks, magnetic disks, and so forth). The memory/storage 1212 includes fixed media (e.g., RAM, ROM, a fixed hard drive, and so on) as well as removable media (e.g., Flash memory, a removable hard drive, an optical disc, and so forth). The computer-readable media 1206 is configurable in a variety of other ways as further described below.

Input/output interface(s) 1208 are representative of functionality to allow a user to enter commands and information to computing device 1202, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., employing visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 1202 is configurable in a variety of ways as further described below to support user interaction.

Various techniques are described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques are configurable on a variety of commercial computing platforms having a variety of processors.

An implementation of the described modules and techniques is stored on or transmitted across some form of computer-readable media. The computer-readable media includes a variety of media that is accessed by the computing device 1202. By way of example, and not limitation, computer-readable media includes “computer-readable storage media” and “computer-readable signal media.”

“Computer-readable storage media” refers to media and/or devices that enable persistent and/or non-transitory storage of information (e.g., instructions are stored thereon that are executable by a processing device) in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media include but are not limited to RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and are accessible by a computer.

“Computer-readable signal media” refers to a signal-bearing medium that is configured to transmit instructions to the hardware of the computing device 1202, such as via a network. Signal media typically embodies computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 1210 and computer-readable media 1206 are representative of modules, programmable device logic and/or fixed device logic implemented in a hardware form that are employed in some embodiments to implement at least some aspects of the techniques described herein, such as to perform one or more instructions. Hardware includes components of an integrated circuit or on-chip system, an application-specific integrated circuit (ASIC), a field-programmable gate array (FPGA), a complex programmable logic device (CPLD), and other implementations in silicon or other hardware. In this context, hardware operates as a processing device that performs program tasks defined by instructions and/or logic embodied by the hardware as well as a hardware utilized to store instructions for execution, e.g., the computer-readable storage media described previously.

Combinations of the foregoing are also be employed to implement various techniques described herein. Accordingly, software, hardware, or executable modules are implemented as one or more instructions and/or logic embodied on some form of computer-readable storage media and/or by one or more hardware elements 1210. The computing device 1202 is configured to implement particular instructions and/or functions corresponding to the software and/or hardware modules. Accordingly, implementation of a module that is executable by the computing device 1202 as software is achieved at least partially in hardware, e.g., through use of computer-readable storage media and/or hardware elements 1210 of the processing device 1204. The instructions and/or functions are executable/operable by one or more articles of manufacture (for example, one or more computing devices 1202 and/or processing devices 1204) to implement techniques, modules, and examples described herein.

The techniques described herein are supported by various configurations of the computing device 1202 and are not limited to the specific examples of the techniques described herein. This functionality is also implementable all or in part through use of a distributed system, such as over a “cloud” 1214 via a platform 1216 as described below.

The cloud 1214 includes and/or is representative of a platform 1216 for resources 1218. The platform 1216 abstracts underlying functionality of hardware (e.g., servers) and software resources of the cloud 1214. The resources 1218 include applications and/or data that can be utilized while computer processing is executed on servers that are remote from the computing device 1202. Resources 1218 can also include services provided over the Internet and/or through a subscriber network, such as a cellular or Wi-Fi network.

The platform 1216 abstracts resources and functions to connect the computing device 1202 with other computing devices. The platform 1216 also serves to abstract scaling of resources to provide a corresponding level of scale to encountered demand for the resources 1218 that are implemented via the platform 1216. Accordingly, in an interconnected device embodiment, implementation of functionality described herein is distributable throughout the system 1200. For example, the functionality is implementable in part on the computing device 1202 as well as via the platform 1216 that abstracts the functionality of the cloud 1214.

In implementations, the platform 1216 employs a “machine-learning model” that is configured to implement the techniques described herein. A machine-learning model refers to a computer representation that can be tuned (e.g., trained and retrained) based on inputs to approximate unknown functions. In particular, the term machine-learning model can include a model that utilizes algorithms to learn from, and make predictions on, known data by analyzing training data to learn and relearn to generate outputs that reflect patterns and attributes of the training data. Examples of machine-learning models include neural networks, convolutional neural networks (CNNs), long short-term memory (LSTM) neural networks, decision trees, and so forth.

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method comprising:
forming, by a processing device, a prompt to cause a generator machine-learning model to generate a sub-question based on a question;
prompting, by the processing device, generation of a plurality of passage scores by a scoring machine-learning model for a plurality of passages of digital content based on the sub-question;
selecting, by the processing device, a passage from the plurality of passages based on the passage scores; and
forming, by the processing device, an additional prompt to cause a generator machine-learning model to generate an answer to the question based on the question, the additional prompt including the question, the sub-question, and the selected passage as context to the question.

2. The method as described in claim 1, wherein the additional prompt includes a plurality of said sub-questions and a plurality of said selected passages formed over a plurality of iterations.

3. The method as described in claim 1, wherein the plurality of passage scores defines, respectively, an amount of relevance of the plurality of passages to the sub-question.

4. The method as described in claim 1, wherein the forming of the additional prompt arranges the question, a plurality of said sub-questions, and a plurality of said passages sequentially corresponding to an order used over a plurality of iterations to form the plurality of said sub-questions.

5. The method as described in claim 1, wherein the forming of the prompt and the forming of the additional prompt are performed by a first machine-learning model and the plurality of passage scores are generated using a second machine-learning model.

6. The method as described in claim 5, wherein the first and second machine-learning models are configured, respectively, as large language models (LLMs).

7. The method as described in claim 1, wherein the forming of the additional prompt to generate the answer to the question is performed responsive to detecting that a stopping criterion has been met.

8. The method as described in claim 7, wherein the stopping criterion is based on a detected likelihood of redundancy of a respective said sub-question in generating the answer.

9. The method as described in claim 7, wherein the stopping criterion is based on an effect on generating the answer by excluding a respective said sub-question.

10. The method as described in claim 1, wherein the plurality of passages is included in a single item of digital content.

11. A system comprising:
a prompt generator module implemented by a processing device to form prompts configured to cause one or more machine-learning models to generate one or more sub-questions based on a question over a plurality of iterations;
a scoring module implemented by the processing device to form a plurality of passage scores for a plurality of passages, respectively, based on the one or more sub-questions using the one or more machine-learning models for respective said iterations; and
a passage selection module implemented by the processing device to:
select a passage from the plurality of passages that is usable to provide context to a subsequent said sub-question for a subsequent said iteration based on the plurality of passage scores; and
prompt the one or more machine-learning models to generate an answer to the question using the question, the one-or-more sub-questions, and the selected passage.

12. The system as described in claim 11, wherein the prompt formed to generate the answer includes a plurality of said sub-questions arranged sequentially in order of formation by the prompt generator module over the plurality of iterations.

13. The system as described in claim 11, wherein the prompt generator module is configured to form at least one said prompt that includes the question and at least one said sub-question.

14. The system as described in claim 11, wherein:
the prompt generator module is configured to prompt a generator module implementing a first large language model (LLM) of the one or more machine-learning models; and
the scoring module is configured to generate the plurality of passage scores using a second large language module (LLM) of the one or more machine-learning models.

15. The system as described in claim 11, wherein the passage selection module is configured to prompt the one or more machine-learning models to generate the answer responsive to detecting that a stopping criterion has been met.

16. The system as described in claim 15, wherein the stopping criterion is based on a detected likelihood of redundancy of a respective said sub-question in generating the answer.

17. The system as described in claim 15, wherein the stopping criterion is based on an effect on generating the answer by excluding a respective said sub-question.

18. One or more computer-readable storage media having instructions stored thereon that, responsive to execution by a processing device, causes the processing device to perform operations comprising:
forming prompts configured to cause one or more machine-learning models to generate one or more sub-questions based on a question over a plurality of iterations;
forming a plurality of passage scores for a plurality of passages, respectively, based on the one or more sub-questions using the one or more machine-learning models for respective said iterations;
selecting a passage from the plurality of passages that is usable to provide context to a subsequent said sub-question for a subsequent said iteration based on the plurality of passage scores; and
prompting the one or more machine-learning models to generate an answer to the question using the question, the one-or-more sub-questions, and the selected passage.

19. The one or more computer-readable storage media as described in claim 18, wherein a prompt used in the prompting of the one or more machine-learning models to generate the answer to the question arranges the plurality of said passages sequentially corresponding to an order used for selection over the plurality of iterations.

20. The one or more computer-readable storage media as described in claim 18, wherein a prompt used in the prompting of the one or more machine-learning models to generate the answer to the question arranges the plurality of said sub-questions sequentially corresponding to an order used for formation over the plurality of iterations.
